(19) United States
(12) Patent Application Publication
(10) Pub. No.: US 2009/0160134 A1
(43) Pub. Date: Jun. 25, 2009

(54) Rotary transmission leadthrough and torque transmission device with a rotary transmission leadthrough

(75) Inventors: Uwe Bastian, Gaggenau (DE); Marco Grethel, Buhlertal (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/214,409

(22) Filed: Jun. 17, 2008

Related U.S. Application Data
(63) Continuation of application No. PCT/DE2006/002104, filed on Nov. 29, 2006.

(30) Foreign Application Priority Data
Dec. 17, 2005 (DE) 10 2005 060 571.0

(51) Int. Cl. F16J 15/34

(52) U.S. Cl. 277/377; 277/387

(57) ABSTRACT

The invention relates to a rotary transmission leadthrough for passing a medium through between a fixed part and a rotary part rotable relative to the fixed part, wherein a stop device, in particular a stop disc, is arranged between the fixed part and the rotary part. The invention is distinguished by the fact that the stop device, in particular the stop disc, is prestressed against the rotary part in the axial direction.

The invention relates to a rotary transmission leadthrough for passing a medium through between a stationary fixed part and a rotating part rotatable relative to the fixed part, wherein a thrust device, in particular a thrust washer, is situated between the fixed part and the rotating part. The invention also relates to a torque transmission device with a rotary transmission leadthrough.

The object of the invention is to improve the leak tightness of a rotary transmission leadthrough according to the preamble of claim 1.

The problem is solved in a rotary transmission leadthrough for passing a medium through between a stationary fixed part and a rotating part rotatable relative to the fixed part, wherein a thrust device, in particular a thrust washer, is situated between the fixed part and the rotating part, by prestressing the thrust device, in particular the thrust washer, against the rotating part in the axial direction. The thrust device preferably has the form of a circular ring disk, but can also be of angular design, and may have for example the form of a cuboid with at least one through hole. In the axial direction means in the direction of or parallel to the axis of rotation of the rotating part. The intentional prestressing of the thrust device against the rotating part holds the two parts in contact with each other, and reliably prevents a gap from developing between the thrust device and the rotating part, through which the medium can escape.

A preferred exemplary embodiment of the rotary transmission leadthrough is characterized by there being an elastically deformable prestressing device clamped between the thrust device and the fixed part. The prestressing device produces an axial force on the thrust device, and also ensures prestressing of the thrust device against the rotating part when the latter is standing still.

Another preferred exemplary embodiment of the rotary transmission leadthrough is characterized by the prestressing device including at least one spring element, which is clamped between the thrust device and the fixed part. The spring element is for example a helical compression spring.

Another preferred exemplary embodiment of the rotary transmission leadthrough is characterized by the prestressing device including at least one sealing element made of an elastically deformable material. According to one aspect of the invention, the sealing element has a dual function. On the one hand, the sealing element produces a prestressing force on the thrust device. On the other hand, the sealing element simultaneously seals off a gap between the thrust device and the fixed part. That prevents unwanted escaping of medium through this gap.

Another preferred exemplary embodiment of the rotary transmission leadthrough is characterized by the fact that the sealing element is formed by an O-ring. The O-ring is preferably made of an elastomeric plastic.

Another preferred exemplary embodiment of the rotary transmission leadthrough is characterized by the fact that the sealing element is situated essentially coaxially to the rotating part. That ensures that the medium cannot escape outward in the radial direction.

Another preferred exemplary embodiment of the rotary transmission leadthrough is characterized by the fact that at least one pressure chamber is formed between the thrust device and the fixed part, in which the forenamed medium or another may be subjected to pressure. When the medium is under pressure, the pressure device is prestressed against the rotating part by the medium in the pressure chamber.

Another preferred exemplary embodiment of the rotary transmission leadthrough is characterized by the fact that the pressure chamber has the form of an annular space, which is bounded by the two O-rings that are clamped between the thrust device and the fixed part. That ensures sealing of the pressure chamber in a simple manner.

Another preferred exemplary embodiment of the rotary transmission leadthrough is characterized by the fact that a plurality of pressure chambers are formed between the thrust device and the fixed part, in which the forenamed medium or another may be subjected to pressure. The pressure chambers are preferably distributed around the circumference of the thrust device in such a way that unwanted skewness of the thrust device is prevented.

Another preferred exemplary embodiment of the rotary transmission leadthrough is characterized by the fact that the pressure chambers are each bounded by an O-ring that is clamped between the thrust device and the fixed part. That ensures sealing of the pressure chambers toward the outside in a simple manner.

Another preferred exemplary embodiment of the rotary transmission leadthrough is characterized by the fact that the thrust device is movable in the axial direction, and in the circumferential direction is non-rotatably connected to the fixed part. The axial movability of the thrust device makes it possible to prestress the thrust device against the rotating part. The non-rotatable connection prevents the thrust device from turning relative to the fixed part.

Another preferred exemplary embodiment of the rotary transmission leadthrough is characterized by the fact that the non-rotatable connection includes at least one coupling pin, whose ends are received in receiving spaces that are provided in the fixed part and the thrust device. One of the receiving spaces has some free play opposite the corresponding end of the coupling pin, which is also referred to as a cylinder pin, in order to ensure that the thrust device can move axially.

Another preferred exemplary embodiment of the rotary transmission leadthrough is characterized by the fact that the non-rotatable connection has at least one threaded connecting element with a shoulder. The shoulder ensures that the thrust device can move axially.

Another preferred exemplary embodiment of the rotary transmission leadthrough is characterized by the fact that the non-rotatable connection has at least one threaded connecting element with a sleeve. The sleeve ensures that the thrust device can move axially.

The invention also relates to a torque transmission device with a rotary transmission leadthrough as described previously.

Additional advantages, features and details of the invention derive from the following description, in which various exemplary embodiments are described in detail with reference to the drawing. The figures show the following:

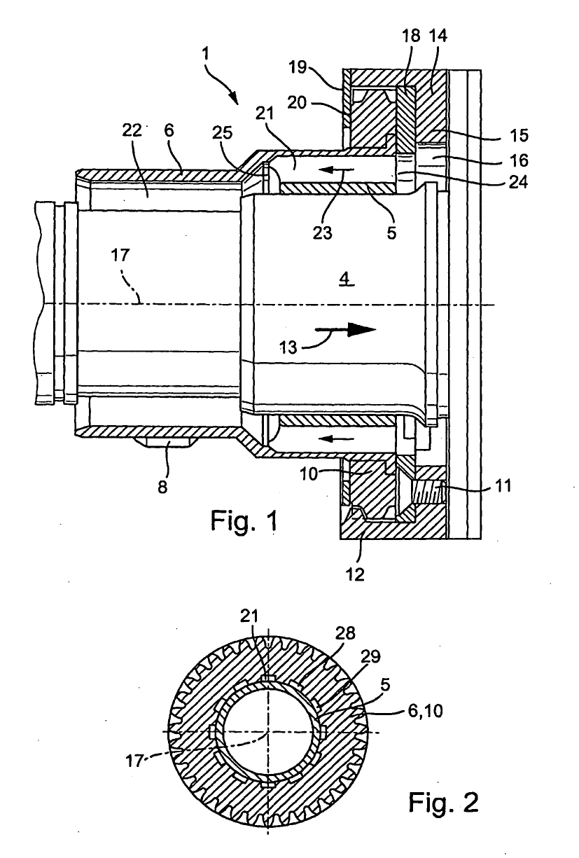

FIG. 1: a partial section through a torque transmission device in the power train of a motor vehicle;

FIG. 2: a sectional view through a driving gear wheel of a pump in the torque transmission device from FIG. 1;

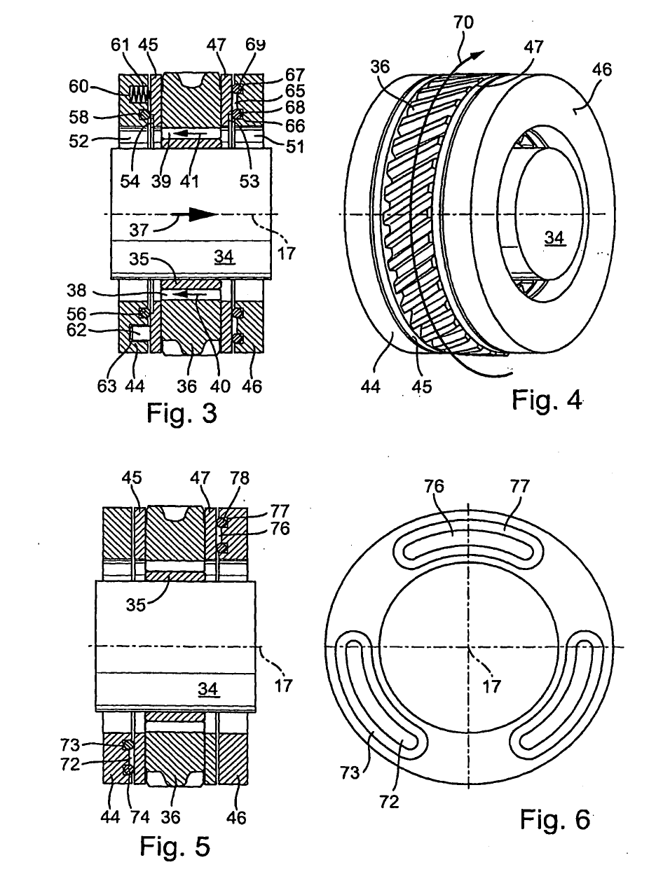

FIG. 3: a longitudinal section through a rotary transmission leadthrough according to a first exemplary embodiment;

FIG. 4: the rotary transmission leadthrough from FIG. 3 in a perspective view;

FIG. 5: a longitudinal section through a rotary transmission leadthrough according to another exemplary embodiment;

FIG. 6: a fixed part of the rotary transmission leadthrough from FIG. 5 in top view;

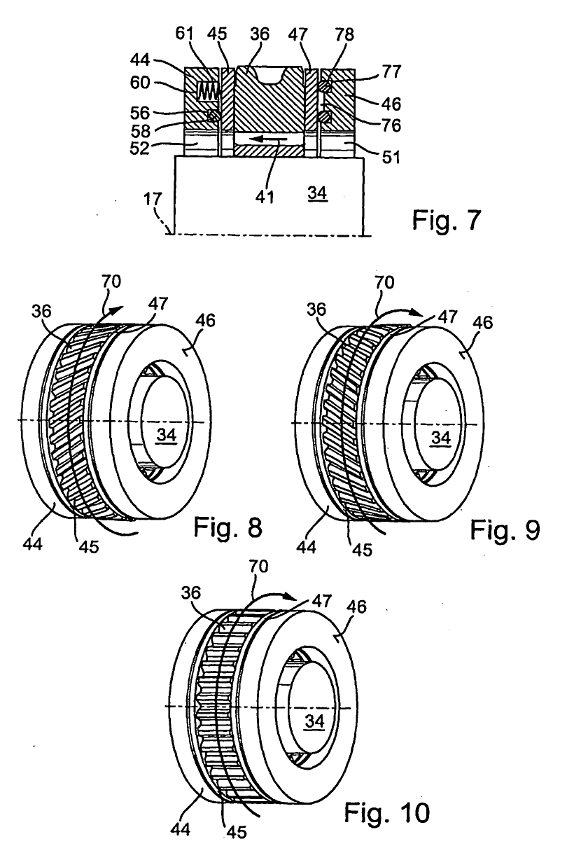

FIG. 7: a half-sectional view through a rotary transmission leadthrough according to another exemplary embodiment;

FIG. 8: a rotary transmission leadthrough according to another exemplary embodiment, in perspective view;

FIG. 9: a perspective view through a rotary transmission leadthrough according to another exemplary embodiment;

FIG. 10: a perspective view through a rotary transmission leadthrough according to another exemplary embodiment;

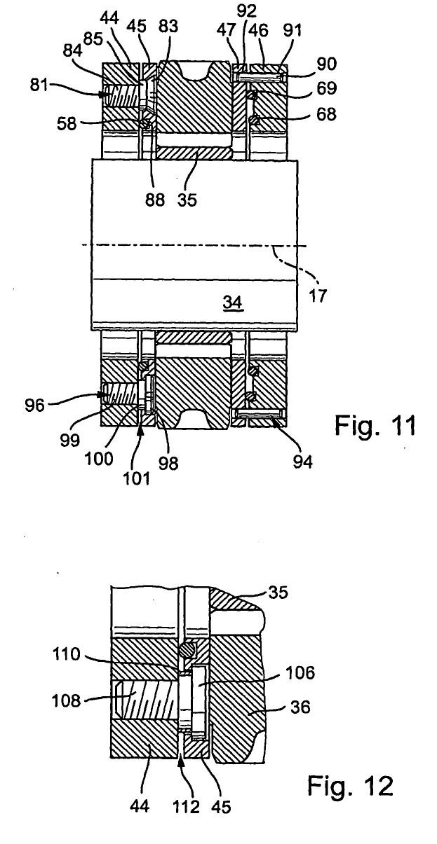

FIG. 11: a longitudinal sectional view through a rotary transmission leadthrough according to another exemplary embodiment; and

FIG. 12: a detail from FIG. 11 according to another exemplary embodiment.

FIG. 1 depicts part of a torque transmitting device in the power train of a motor vehicle in longitudinal sectional view. The torque transmitting device 1 is situated between a drive unit, in particular a combustion engine, from which a crankshaft emerges, and a transmission, and includes a clutch, in particular a clutch of lamellar construction. The construction and function of a clutch of lamellar construction are assumed to be known, and therefore will not be explained further here. The crankshaft of the combustion engine can be coupled through the clutch to the input shaft 4 of the transmission. A coupling element 6 is rotatably supported on the transmission input shaft 4 with the aid of a bearing device 5. Coupling element 6 is connected through a driver element 8 to the crankshaft of the combustion engine in a rotationally fixed connection. Through this rotationally fixed connection a drive wheel 10 of a pump is driven, which is connected to coupling element 6 in a rotationally fixed connection. Drive wheel 10 of the pump is equipped with preferably oblique external gearing, which meshes with complementary external gearing on a pump wheel 12.

If the meshed teeth of the two gears are executed as oblique gearing, then an axial force is produced by the oblique gearing. Depending on the skewing of the teeth, the axial force can also act in the opposite direction.

The two gear wheels 10, 12 are situated in a stationary housing 14. In the area of the driving gear 10 the housing has a shoulder 15, which is also referred to as a fixed part. In a radial direction between fixed part 15 and transmission input shaft 4, a ring-shaped receiving space 16 for a medium is situated. The medium is preferably cooling oil for the clutch.

Transmission input shaft 4, coupling element 6 and driving gear 10 have a common axis of rotation 17. The terms radial, axial and in the circumferential direction used in the previous description refer to the axis of rotation 17. In an axial direction between driving gear 10 and fixed part 15 a thrust washer 18 is situated. Thrust washer 18 is attached to fixed part 15 with the aid of threaded connections 11. On the side facing away from fixed part 15, driving gear 10 is secured in the axial direction by a retaining plate 19. There is axial free play 20 between driving gear 10 and retaining plate 19.

The receiving space 16 for the medium is connected via a connecting line (not shown) to the pressure chamber of a pump, from which the receiving space 16 is supplied with the medium, preferably with cooling oil. The cooling oil flows from the receiving space 16 through fins 21 into a larger annular space 22, which is present in the radial direction between transmission input shaft 4 and coupling element 6. From the larger annular space 22 the cooling oil then passes to the clutch that is to be provided with cooling oil. Because of a pressure drop in the fins 21, a higher pressure prevails in the receiving space 16 than in the larger annular space 22. The area with the receiving space 16 is also referred to as the primary side. Analogously, the area with the larger annular space 22 is also referred to as the secondary side. The higher pressure on the primary side can lead to the result that, depending on the ratio of the pressurized areas 24, 25 on the primary and secondary sides, as well as the level of the oil pressure, and depending on the axial force 13 caused by the oblique gearing, driving gear 10 may lift away from thrust washer 18 against axial force 13. If driving gear 10 lifts away from thrust washer 18, then the sealing function that is supposed to be brought about by the axial force 13 and the thrust washer 18 is no longer assured. Thrust washer 18 is made for example of gray cast iron, aluminum or plastic. The magnitude of the axial force 13 brought about by the oblique gearing is dependent on the torque that is needed to produce a particular oil pressure, and on the helix angle of the gearing.

A skewness of driving gear 10 relative to thrust washer 18 can occur in the rotary transmission leadthrough depicted in FIG. 1, due to imprecisions in manufacturing. Furthermore, driving wheel 10 can be retracted from thrust washer 18 when the clutch is standing still. In both cases, during operation of the pump a gap can occur between driving gear 10 and thrust washer 18, with the result that the higher cooling oil pressure on the primary side acts on a larger area as a result of the gap. That causes an axial force contrary to the axial force 13 caused by the oblique gearing to be produced on the primary side, which can nullify the sealing function of thrust washer 18.

FIG. 2 hints that that there may be not only one fin 21, but a plurality of fins 28, 29 distributed around the circumference of bearing device 5 between the bearing device and coupling element 6 or the driving gear 10 of the pump. The fins 21, 28, 29 serve to guide the stream of cooling oil in the axial direction from receiving space 16 into annular space 22, as indicated in FIG. 1 by an arrow 23. The pressure drop in the fins depends in part on the shape and the cross section of the fins, as well as the volume transported, the pressure level of the cooling oil, and the ratio of areas between the primary and secondary sides.

FIGS. 3 through 12 show a variety of measures for improving the transfer of the cooling oil from a stationary part to a rotating part and vice versa.

FIGS. 3 and 4 show a rotary transmission leadthrough according to the invention with a transmission input shaft 34, in longitudinal section and perspective view. A driving gear 36 is rotatably supported relative to the transmission input shaft 34 with the aid of a bearing device 35. Driving gear 36 is equipped with oblique gearing, which produces an axial force 37 when a cooling oil pump driven by driving gear 36 is operating. Driving gear 36 is provided radially on the inside with a plurality of fins 38, 39, which enable cooling oil to pass through in the radial direction between bearing device 35 and driving gear 36, as indicated by arrows 40, 41.

Transmission input shaft 34 is passed through a stationary housing part 44, which is also referred to as a fixed part. A thrust washer 45 is situated between the fixed part 44 and the driving wheel 36. On the other side, the transmission input shaft 34 is passed through another stationary housing part 46, which is likewise referred to as a fixed part. Another thrust washer 47 is situated between the fixed part 46 and the driving wheel 36. The thrust washers 45 and 47 both have the form of circular ring disks with a rectangular cross section. The inside diameter of thrust washers 45 and 47 corresponds approximately to the outside diameter of two ring-shaped receiving spaces or pass-through spaces 51, 52 for cooling oil. The outside diameter of thrust washers 45 and 47 corresponds approximately to the outside diameter of driving gear 36.

Receiving space 51, which is also referred to as an annular space, is connected through a connecting line (not shown) to the pressure chamber of a pump, from which cooling oil is transported into receiving space 51 when driving gear 36 is driving the pump. In connection with the present invention driving gear 36 is also referred to as a rotating part, since it turns relative to the fixed parts 44 and 46 when the pump is operating. Thrust washers 45 and 47, which are situated in the axial direction between fixed parts 44, 46 and rotating part 36, do not turn. According to an essential aspect of the invention, thrust washers 45, 47 are prestressed in the axial direction against rotating part 36. The term axial direction in connection with the present invention means in the direction of the axis of rotation of rotating part 36 and of transmission input shaft 34. The prestressing of thrust washers 45, 47 against rotating part 36 is caused by axial forces that act on thrust washers 45, 47 from the direction of fixed parts 44, 46. These axial forces, which are also referred to as tensioning forces, cause a gap to appear between fixed parts 44, 46 and the corresponding thrust washers 45, 47. The surface subjected to the primary-side pressure is identified in FIG. 3 as 53. The surface subjected to the secondary-side pressure is identified in FIG. 3 as 54.

On the secondary side—that is, on the side of the receiving space 52—the pre-stressing force is exerted on thrust washer 45 in part by an O-ring which is clamped between fixed part 44 and thrust washer 45. O-ring 58 is partially received in an annular groove 56, which has a rectangular cross section and extends in fixed part 44 coaxially with axis of rotation 17. The O-ring 58 clamped between fixed part 44 and thrust washer 45 produces an axial force on thrust washer 45. In addition, O-ring 58 seals off the gap between fixed part 44 and thrust washer 45 radially toward the outside. Hence the pressurized surface 54 on the secondary side is bounded in the radial direction by O-ring 58. Radially outside of O-ring 58 a plurality of blind holes 60, 62 are recessed in fixed part 44; a spring element 61, 63 is received in each of them. The spring elements 61, 63 are formed for example by helical compression springs, and are clamped between fixed part 44 and thrust washer 45. Preferably, a plurality of blind holes with spring elements are distributed at uniform intervals in the circumferential direction.

Additional axial forces are applied to thrust washer 45 by spring elements 61, 63. The additional spring elements 61, 63 can be arranged at will inside or outside of the pressurized areas. The axial forces caused by the O-ring 58 and the additional spring elements 61, 63 serve to pre-stress thrust washer 45 against rotating part 36. Furthermore, these axial forces, when they act in the direction opposite the axial force 37 caused by the oblique gearing, can also serve to reduce the effect of the axial force 37 produced by the oblique gearing. In the exemplary embodiment depicted in FIG. 3, spring elements 61, 63 and O-ring 58 produce additional axial forces, which act on the secondary side in the same direction as the axial force 37 caused by the oblique gearing. The axial force 37 is thus increased selectively. That makes it possible to build up a defined opposing force to the axial force, which is produced as a consequence of the passage of cooling oil through fins 38, 39.

On the primary side, a ring-shaped pressure chamber 65 is provided between thrust washer 47 and fixed part 46. The pressure chamber 65 is bounded in the axial direction by thrust washer 47 and fixed part 46. In the radial direction, pressure chamber 65 is bounded by two O-rings 68, 69, which are partially received in ring grooves 66, 67. The ring grooves 66, 67 run in fixed part 46 coaxially to the axis of rotation 17, and have a rectangular cross section. The two O-rings 68, 69, like O-ring 58 on the primary side, are made of an elastically deformable plastic material. A pressurizable medium, preferably cooling oil, is situated in pressure chamber 65. In the illustrated example pressure chamber 65, which is also referred to as an annular space, is connected with the pressure chamber of the pump through a connecting line, which is not shown. In FIG. 4, the direction of rotation of driving gear 36 is indicated by an arrow 70.

Rotary transmission leadthroughs similar to those in FIGS. 3 and 4 are depicted in various views in FIGS. 5 through 12. The same reference labels are used to identify the same or similar parts. To avoid repetitions, we refer to the earlier description of FIGS. 3 and 4. The next section will examine only the differences between the individual exemplary embodiments.

In the exemplary embodiment depicted in FIGS. 5 and 6, a pressure chamber 72 is provided on the secondary side between fixed part 44 and thrust washer 45. However, pressure chamber 72 is not an annular space, but a partial pressure chamber of essentially kidney-shaped design, as indicated in FIG. 6, and is bounded by a groove 73 which also runs in a kidney shape. An O-ring 74 which seals the pressure chamber 72 against the outside is partially received in the groove 73. Analogously, on the primary side a pressure chamber which is bounded by an O-ring 78 is formed between fixed part 46 and thrust washer 47. O-ring 78 is partially received in a kidney-shaped groove 77. Preferably, three pressure chambers are distributed uniformly around the circumferences of fixed parts 44, 46, as indicated in FIG. 6. O-rings 74, 78 are made of an elastically deformable material, and are clamped between the fixed part and the thrust washer. As a result, the O-rings exert an axial force on the corresponding thrust washer.

In addition, pressure chambers 72, 76 are filled with cooling oil which is under pressure. As a result, an additional axial force is exerted on the corresponding thrust washers. When these axial forces act against the axial force that is caused by the oblique gearing, they can also serve to reduce the effect of the axial force caused by the oblique gearing, in order to increase the degree of efficiency by reducing the contact pressure. The axial force that is exerted by the oblique gearing in the direction of a fixed part can be increased selectively through these additional axial forces, for example when they act only on the secondary side, in order to build up a defined opposing force to the axial force that arises due to the pressure drop as a consequence of the passage of cooling oil through the fins of the rotary transmission leadthrough.

FIG. 7 indicates that O-ring 58, spring element 61 and pressure field 76 can be combined with each other in nearly unlimited ways. FIGS. 8 and 9 indicate that the oblique gearing can have different directions of obliqueness. FIG. 10 indicates that driving gear 36 can also have straight teeth. Naturally, the helix angle can also be changed. In conjunction with the present invention it has been found advantageous to choose the effective direction of the axial force produced by the oblique gearing so that it counteracts the force that arises due to the pressure drop resulting from the passage of cooling oil through the fins. Furthermore, the additional elastic elements 61, 63 and the O-rings can be not only partially received in the fixed parts, as shown, but can also be partially received in the thrust washers. To this end, thrust washers 45, 47 must be provided with corresponding annular grooves, kidney-shaped grooves or blind holes.

FIGS. 11 and 12 depict various measures for preventing unwanted turning of the thrust washers 45, 47 relative to the corresponding fixed part 44, 46. FIG. 11 indicates on the secondary side that thrust washer 45 is held to fixed part 44 with the aid of a countersunk screw 81. Countersunk screw 81 has a countersunk head 83, which is situated in a complementarily formed through hole of screw 81. From countersunk head 83 a screw shaft 84 with a threaded section emerges, which is screwed into a complementarily formed threaded hole in fixed part 44. Countersunk screw 81 has a shoulder 85, which makes axial free play 101 possible between fixed part 44 and thrust washer 45. Radially inside of countersunk screw 81, thrust washer 45 is provided with a ring groove 88, in which an O-ring 58 is partially received.

On the primary side it is indicated that thrust washer 47 can also be prevented from turning by a cylinder pin 90. One end of cylinder pin 90 is received in a through hole 91, which is recessed in fixed part 46. The other end of cylinder pin 90 is received with free play in a through hole 92, which is recessed in thrust washer 47. The free play makes it possible for thrust washer 47 to move in the axial direction relative to fixed part 46. Radially inside of cylinder pin 90, two O-rings 68, 69 are clamped between thrust washer 47 and fixed part 46.

The antirotation protection can include an additional cylinder pin 94, or still other cylinder pins. The antirotation protection can also be accomplished by a flat-head screw 96, which has a flat head 98 that is received in a stepped hole in thrust washer 45. From flat head 98 a screw shaft 99 with a threaded section emerges, which is screwed into a corresponding threaded hole in fixed part 44. Flat-head screw 96 has a shoulder 100. The shoulder 100, like the shoulder 85 on countersunk screw 81, serves to realize the axial free play 101 between thrust washer 45 and fixed part 44. Furthermore, there is some radial play present between the flat head 98 with the shoulder 100 and the stepped through hole, in order to enable axial movement of thrust washer 45 relative to fixed part 44. The remaining axial free play between thrust washer 45 and fixed part 44 can be adjusted over the length of the shoulders 85, 100. The axial free play 101 serves as spring travel distance.

FIG. 12 indicates that the antirotation protection can also be realized with the aid of a pan head screw 106, which has a screw shaft 108 that is screwed into fixed part 44. In this case a sleeve is clamped between the screw head of pan-head screw and fixed part 44 in order to realize the necessary axial free play 112 between fixed part and thrust washer. The sleeve 110 makes it possible to tune the magnitude of the axial free play 112 in a simple manner.

### REFERENCE NUMERAL LIST

1. torque transmission device
4. transmission input shaft
5. bearing device
6. coupling element
8 driver element
10. driving wheel
11. threaded connection
12. pump gear wheel
13. arrow
14. housing
15. shoulder
16. receiving space
17. axis of rotation
18. thrust washer
19. retaining plate
20. free play
21. fin
22. annular space
23. arrow
24. surface
25. surface
28. fin
29. fin
34. transmission input shaft
35. bearing device
36. driving gear
37. axial force
38. fin
39. fin
40. arrow
41. arrow
44. fixed part
45. thrust washer
46. fixed part
47 thrust washer
51. receiving space
52. receiving space
53. surface
54. surface
56. annular groove
58. O-ring
60. blind hole
61. spring element
62. blind hole
63. spring element
65. pressure chamber
66. annular groove
67. annular groove
68. O-ring
69. O-ring
70. arrow
72. pressure chamber
73. groove
74. O-ring
76. pressure chamber
77. groove
78. O-ring
81. countersunk screw
83. countersunk head
84. screw shaft
85. shoulder
88. groove
90. cylinder pin
91. through hole
92. through hole
94. cylinder pin
96. flat-head screw
98. flat head
99. screw shaft
100. shoulder
101. free play
106. pan head screw
108. screw shaft
110. sleeve
112. free play

1. Rotary transmission leadthrough for passing a medium through between a stationary fixed part (14; 44, 46) and a rotating part (10, 36) that is rotatable relative to the fixed part, there being a thrust device (18; 45, 47), in particular a thrust washer, situated between the fixed part (14; 44, 46) and the rotating part (10; 36), characterized in that the thrust device (45, 47), in particular the thrust washer, is prestressed in the axial direction against the rotating part (36).

2. Rotary transmission leadthrough according to claim 1, characterized in that an elastically deformable prestressing device is clamped between the thrust device (45, 47) and the fixed part (44, 46).

3. Rotary transmission leadthrough according to claim 2, characterized in that the prestressing device includes at least one spring element (61, 63), which is clamped between the thrust device (45) and the fixed part (44).

4. Rotary transmission leadthrough according to claim 2, characterized in that the prestressing device includes at least one sealing element (58, 68, 69, 74, 78) made of an elastically deformable material.

5. Rotary transmission leadthrough according to claim 4, characterized in that the sealing element (58, 68, 69, 74, 78) is formed by an O-ring.

6. Rotary transmission leadthrough according to claim 4, characterized in that the sealing element (58, 68, 69) is situated essentially coaxially to the rotating part.

7. Rotary transmission leadthrough according to claim 1, characterized in that at least one pressure chamber (65, 72, 76), in which the forenamed medium or another one is pressurizable, is formed between the thrust device and the fixed part.

8. Rotary transmission leadthrough according to claim 7, characterized in that the pressure chamber (65) has the form of an annular space that is bounded by two O-rings (68, 69) which are clamped between the thrust device (47) and the fixed part (46).

9. Rotary transmission leadthrough according to claim 7, characterized in that a plurality of pressure chambers (72, 76), in which the forenamed medium or another one is pressurizable, are formed between the thrust device (45, 47) and the fixed part (44, 46).

10. Rotary transmission leadthrough according to claim 9, characterized in that the pressure chambers (72, 76) are each bounded by an O-ring (74, 78) that is clamped between the thrust device (45, 47) and the fixed part (44, 46).

11. Rotary transmission leadthrough according to claim 1, characterized in that the thrust device (45, 47) is connected to the fixed part (44, 46) so that it is movable in the axial direction and non-rotatable in the circumferential direction (44, 46).

12. Rotary transmission leadthrough according to claim 11, characterized in that the non-rotatable connection includes at least one coupling pin (90, 94), whose ends are received in receiving spaces that are provided in the fixed part (46) and the thrust device (47).

13. Rotary transmission leadthrough according to claim 11, characterized in that the non-rotatable connection has at least one threaded connecting element (81; 96) with a shoulder (85; 100).

14. Rotary transmission leadthrough according to claim 11, characterized in that the non-rotatable connection has at least one threaded connecting element (106) with a sleeve (100).

15. Rotary transmission leadthrough according to claim 1, characterized in that the design solution options for applying the pre-stress can be utilized on the primary and/or the secondary side.

16. Rotary transmission leadthrough according to claim 1, characterized in that the direction of the axial forces from the oblique gearing and the elastically deformable prestressing device or the spring elements or the compression spring may be combined with each other in any way desired.

17. Rotary transmission leadthrough according to claim 1, characterized in that the additional spring-action elements and the elastically deformable prestressing device can be received not only in the fixed parts, but also in the thrust washers.

18. Torque transmitting device with a rotary transmission leadthrough according to claim 1.
